(19) United States
(12) Patent Application Publication
(10) Pub. No.: US 2009/0219015 A1
(43) Pub. Date: Sep. 3, 2009

(54) APPARATUS FOR MEASURING KINETIC PARAMETERS OF PUNCH

(75) Inventors: CHIEN-CHUN CHEN, Tu-Cheng (TW); TSANN-HUEI CHANG, Tu-Cheng (TW); HAN-CHIEH CHANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: FOXNUM TECHNOLOGY CO., LTD., Tucheng City (TW)

(21) Appl. No.: 12/140,323

(22) Filed: Jun. 17, 2008

(30) Foreign Application Priority Data
Feb. 28, 2008 (CN) 200810300418.9

(51) Int. Cl. G01B 7/14

(52) U.S. Cl. 324/207.22

(57) ABSTRACT

An exemplary apparatus and method for measuring kinetic parameters of a machining tool within a press molding machine includes two magnets and two electrical conductors attached to a machining tool. The two magnets are fixed for producing two magnetic fields that are at an angle to each other. The two electrical conductors are connected to a controller to form two closed loops respectively. Each electrical conductor is located in a corresponding magnetic field and is unparallel to the direction of the corresponding magnetic field. Upon the condition that the machining tool deviates from its axial path, voltages are induced across the two electrical conductors. The controller receives the induced voltages, and determines a velocity of the machining tool's deviation from the axial path.

### BACKGROUND

1. Field of the Invention

The present invention relates to measuring apparatuses, and particularly to an apparatus and method for measuring kinetic parameters of a punch during press molding.

2. Description of Related Art

In a typical press molding machine, a punch is used to insert into and engage with molding die, so as to make through holes or blind holes in a workpiece. Initially, the workpiece is placed on a molding surface of molding die having a predetermined concave shape. Next, the workpiece is pressed by a punch having a shape corresponding to the concaved portion. Often the punch may be displaced along the molding surface of the molding die during press molding. As a result, the accuracy of the press-molded product may be affected.

What is needed is an apparatus and method for determining the position of the punch during press molding.

### SUMMARY

An exemplary apparatus and method for measuring kinetic parameters of a machining tool within a press molding machine includes two magnets and two electrical conductors attached to a machining tool. The two magnets are fixed for producing two magnetic fields that are at an angle to each other. The two electrical conductors are connected to a controller to form two closed loops respectively. Each electrical conductor is located in a corresponding magnetic field and is unparallel to the direction of the corresponding magnetic field. Upon the condition that the machining tool deviates from its axial path, voltages are induced across the two electrical conductors. The controller receives the induced voltages, and determines a velocity of the machining tool's deviation from the axial path.

Other novel features and advantages will become more apparent from the following detailed description of preferred and exemplary embodiment when taken in conjunction with the accompanying drawings, in which:

### BRIEF DESCRIPTION OF THE DRAWINGS

FIG. 1 is an isometric view of an apparatus for measuring kinetic parameters of a punch in accordance with an exemplary embodiment of the present invention;

FIG. 2 is a schematic view of two conductive wires in two magnetic fields which are respectively produced by two magnets of FIG. 1; and

FIG. 3 is a schematic view showing the relationship between a moving direction of the punch, and field directions of the magnetic fields of FIG. 2.

### DETAILED DESCRIPTION

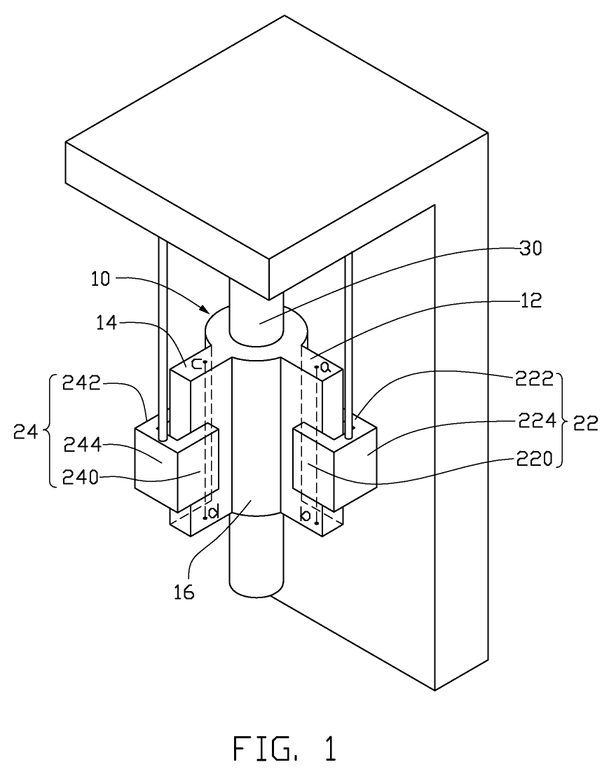

Referring to FIG. 1, an apparatus for measuring kinetic parameters of a punch 30 within a press molding machine is used to accurately determine the position of the punch 30. The apparatus, in accordance with an exemplary embodiment of the present invention, includes a fixing device 10 made of nonconductive material, a pair of U-shaped magnets 22 and 24 and a pair of conductive wires ab and cd.

The fixing device 10 has a hollow cylindrical main body 16 for receiving the punch 30, two rectangular projecting portions 12 and 14 protruding from the main body 16. The conductive wires ab and cd are embedded in the projecting portions 12 and 14 respectively. The projecting portion 12 is perpendicular to the projecting portion 14. In this exemplary embodiment, the conductive wires ab and cd are parallel to the axial direction of the punch 30. The magnet 22 has a north pole 220, a south pole 222, and a bottom part 224 connecting the north pole 220 to the south pole 222 to form a recess. The magnet 24 has a north pole 240, a south pole 242, and a bottom part 244 connecting the north pole 240 to the south pole 242 to form another recess. In this exemplary embodiment, the magnets 22 and 24 are suspended firmly from a ceiling of a worktable of the press molding machine maintained in a fixed position. The projecting portions 12 and 14 are non-contactingly located in the recesses of the magnets 22 and 24 respectively and move with the punch 30. North poles 220, 240 of the magnets 22 and 24 face each other.

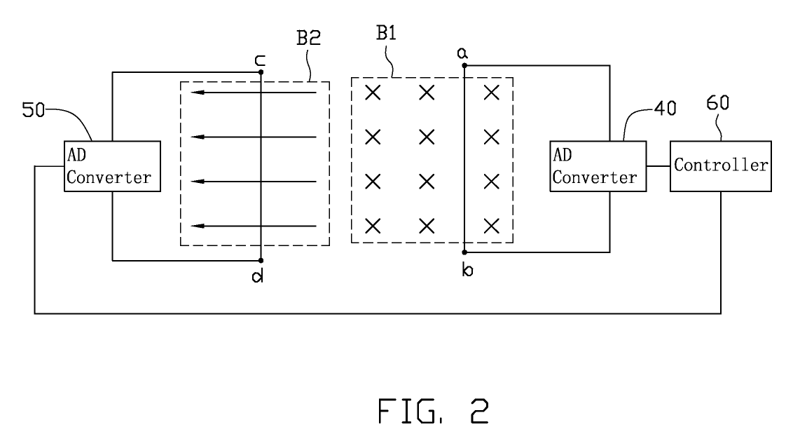

Referring to FIG. 1 and FIG. 2, the magnets 22 and 24 are configured for producing two uniform magnetic fields B1 and B2 that are perpendicular to each other. The conductive wire ab is located within the magnetic field B1, and the conductive wire cd is located within the magnetic field B2. The conductive wires ab and cd are arranged to be perpendicular to their respective magnetic field lies. Two ends of the conductive wire ab are connected to an AD converter 40 to form a closed loop. Two ends of the conductive wire cd are connected to an AD converter 50 to form another closed loop. The AD converters 40 and 50 are both electronically connected to a controller 60 of the press molding machine. The AD converters 40, 50 may be fixed in or on one of the fixing device 10 and the press molding machine.

In use, when the punch 30 moves along its path, it may deviate from its axial direction, the conductive wires ab and cd move in the magnetic fields B1 and B2 respectively, and voltages are induced across the wires ab and cd. The AD converters 40 and 50 convert the voltages from analog values to digital values, respectively. The controller 60 receives the digital values of the voltages and calculates the kinetic velocity of the conductive wires ab and cd.

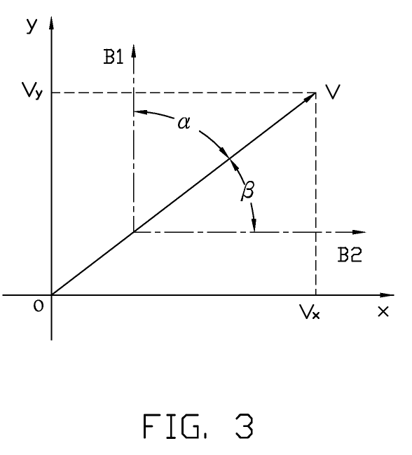

Referring to FIG. 3, a plane coordinate system is defined. In the present embodiment the magnets are set to produce magnetic fields B2 and B1 which perpendicular to each other. The x-axis and y-axis are parallel to the directions of the magnetic fields B2 and B1 respectively. Defining that the speed of the punch 30 deviation from it's axial direction is v, v is made of a x-axis component vx and a y-axis component vy. The values of the two components vx and vy are determined according to the following equations:

$$\{ \begin{matrix}\begin{matrix}{v}_{x} = \frac{e 1}{E 1 * L 1} \\ {v}_{y} = \frac{e 2}{E 2 * L 2}\end{matrix} \\ \begin{matrix}{v}_{y} / {v}_{x} = cos α / cos β \\ β = {90}^{°} - α\end{matrix}\end{matrix}$$

### Wherein:

E1 and E2 are respectively the strength of the magnetic fields B1 and B2

L1 and L2 are respectively the length of the conductive wires ab and cd that are inside and perpendicular to the magnetic fields B1 and B2

α is the angle between a deviating direction of the punch 30 and the direction of the magnetic field B1

β is the angle between the deviating direction of the punch 30 and the direction of the magnetic field B2

e1 and e2 are the digital values of the induced voltages received by the controller 60.

In this exemplary embodiment, the equations pre-set in the controller 60 can be changed according to the user's needs. Given that the magnets are offset by ninety degrees, β is equal to 90°−α (graphic example shown in FIG. 3). In an alternative embodiment, the two end of each of the conductive wires ab and cd can be connected to the controller 60, which receive the induced voltages without going through the AD converters 40 and 50. Also in other embodiments, the angle between the magnets can be set at any angle.

The displacements of the punch 30 along the x-axis and y-axis can be calculated by the controller 60 according to the x-axis component vx and the y-axis component vy respectively. The position of the punch 30 and a workpiece to be punched by the press molding machine can be adjusted by the controller 60 according to the displacements of the punch 30 along the x-axis and y-axis respectively. Therefore, the press molding machine works more accurately.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An apparatus for measuring kinetic parameters of a press, the apparatus comprising:
first and second fixed magnets for producing first and second magnetic fields that are at an angle to each other;
a fixing device attached to a machining tool; and
first and second electrical conductors located in the fixing device, two ends of each of the first and second electrical conductors are connected to a controller to form two closed loops respectively;
wherein the first and second electrical conductors are respectively located in the first and second magnetic fields, and are configured to travel perpendicular to the field direction of the first and second magnetic fields during an axial path of the machining tool; upon the condition that the machining tool deviates from its axial path, voltages are induced across the first and second electrical conductors; the controller is capable of receiving the induced voltages, determining a velocity of the machining tool's deviation from the axial path.

2. The apparatus as claimed in claim 1, further comprising first and second analog-digital converters, the two ends of the first electrical conductor are connected to the controller via the first analog-digital converter, and the two ends of the second electrical conductor are connected to the controller via the second analog-digital converter, the first and second analog-digital converters are capable of converting the induced voltages from analog values to digital values.

3. The apparatus as claimed in claim 2, wherein the controller is capable of determining the components of the velocity by the induced voltages across the first and second electrical conductors, the strengths of the first and second magnetic fields, and the effective lengths of the first and second electrical conductors.

4. The apparatus as claimed in claim 1, wherein the fixing device is made of nonconductive material, and comprises:
a hollow main body for receiving the machining tool; and
first and second projecting portions protruding from the main body:
the first and second electrical conductors are respectively embedded in the first and second projecting portions.

5. The apparatus as claimed in claim 4, wherein each of the first and second magnets has a north pole, a south pole, and a bottom part connecting the north pole to the south pole to form a recess, and the first and second projecting portions are respectively located in the recesses of the first and second magnets.

6. The apparatus as claimed in claim 1, wherein the machining tool is configured to accept data from the controller and adjust the movement of the machining tool accordingly.

7. The apparatus as claimed in claim 6, wherein the machining tool is a punch.

8. The apparatus as claimed in claim 1, wherein the first and second electrical conductors are conductive wires.

9. An apparatus for measuring kinetic parameters of a machining tool, the apparatus comprising:
first and second fixed magnets for producing first and second magnetic fields which are perpendicular to each other; and
first and second electrical conductors attached to the machining tool, two ends of each of the first and second electrical conductors are connected to a controller of the press molding machine to form two closed loops respectively;
wherein the first and second electrical conductors are respectively located in the first and second magnetic fields, and are configured to travel perpendicular to the direction of the first and second magnetic fields; upon the condition that the machining tool is deviates from a predetermined path, the first and second magnetic fields are capable of inducing voltages across the first and second electrical conductors; the controller is capable of receiving the induced voltages, and the controller calculates the non-predetermined path velocity of the machining tool.

10. The apparatus as claimed in claim 9, further comprising first and second analog-digital converters, the two ends of the first electrical conductor are connected to the controller via the first analog-digital converter, and the two ends of the second electrical conductor are connected to the controller via the second analog-digital converter, the first and second analog-digital converters are capable of converting the induced voltages from analog values to digital values.

11. The apparatus as claimed in claim 9, wherein the velocity of the machining tool comprises a first and second components along the directions of the first and second magnetic fields respectively, the controller is capable of determining the first and second components by induced voltages across the first and second electrical conductors, the strengths of the first and second magnetic fields, and by the effective lengths of the first and second electrical conductors respectively within the first and second magnetic fields.

12. The apparatus as claimed in claim 1, further comprising a fixing device made of nonconductive material, the fixing device comprises:
a hollow main body for receiving the machining tool; and
first and second projecting portions protruding from the main body;
the first and second electrical conductors are respectively embedded in the first and second projecting portions.

13. The apparatus as claimed in claim 12, wherein each of the first and second magnets has a north pole, a south pole, and a bottom part connecting the north pole to the south pole to form a recess, the first and second projecting portions are respectively located in the recesses of the first and second magnets.

14. The apparatus as claimed in claim 9, wherein the first and second magnetic fields are uniform.

15. The apparatus as claimed in claim 9, wherein the first and second electrical conductors are conductive wires.

16. The apparatus as claimed in claim 9, wherein the machining tool is a punch.

17. A method for measuring kinetic parameters of a machining tool, comprising:
providing first and second magnets for producing first and second magnetic fields which are perpendicular to each other;
attaching first and second electrical conductors to the machining tool;
connecting the first and second electrical conductors to a controller of the press molding machine to form two closed loops respectively; and
moving the first and second electrical conductors in the first and second magnetic fields non-perpendicular to the field direction of the first and second magnetic fields respectively, and inducing voltages across the first and second electrical conductors;
the controller receiving the induced voltages, and calculates non-perpendicular velocity of the electrical conductors according to the induced voltages.

18. The method as claimed in claim 17, further comprising:
providing a first analog-digital converter connected between the two ends of the first electrical conductor, and connected to the controller;
providing a second analog-digital converter connected between the two ends of the second electrical conductor, and connected to the controller;
the first and second analog-digital converters convert the induced voltages from analog values to digital values; and
the controller receives the digital values of the induced voltages from the first and second analog-digital converters.

19. The method as claimed in claim 17, wherein the attaching step comprising:
providing a fixing device made of nonconductive material which comprises a hollow
main body and first and second projecting portions protruding from the main body;
receiving the machining tool in the main body; and
locating the first and second electrical conductors respectively embedded in the first and second projecting portions.

20. The method as claimed in claim 19, wherein each of the first and second magnets has a north pole, a south pole, and a bottom part connecting the north pole to the south pole to form a recess, the first and second projecting portions situated in the recesses of the first and second magnets.

21. The method as claimed in claim 17, wherein the first and second magnetic fields are uniform.

22. The method as claimed in claim 17, wherein the first and second electrical conductors are conductive wires.

23. The method as claimed in claim 17, wherein the velocity of the machining tool comprises of first and second components along the directions of the first and second magnetic fields respectively, the ratio of the first and second components is equal to the ratio of the cos of the angle between the direction of the machining tool deviation and the first magnetic field and the cos of the angle between the direction of the machining tool deviation and the second magnetic field; the controller determines the first component by dividing the induced voltage across the first electrical conductor by a calculation of multiplying the strength of the first magnetic field by the effective lengths of the first electrical conductor within the first magnetic fields.

24. The method as claimed in claim 23, wherein the machining tool is a punch.

25. The method as claimed in claim 17, wherein the controller can make adjustments to the processes of the press molding machine.
